(19) United States
(12) Patent Application Publication
(10) Pub. No.: US 2019/0391261 A1
(43) Pub. Date: Dec. 26, 2019

(54) SYSTEM AND METHOD FOR ESTIMATING TRAJECTORY OF OBJECT IN 3 DIMENSIONS

(71) Applicant: Electronics and Telecommunications Research Institute, Daejeon (KR)

(72) Inventors: Sang Woo SEO, Daejeon (KR); Myung Gyu KIM, Daejeon (KR); Woo Suk KIM, Daejeon (KR)

(73) Assignee: Electronics and Telecommunications Research Institute, Daejeon (KR)

(21) Appl. No.: 16/177,599

(22) Filed: Nov. 1, 2018

(30) Foreign Application Priority Data
Jun. 22, 2018 (KR) 10-2018-0072016

(51) Int. Cl. G01S 15/58; G01S 13/58; G01S 15/02

(52) U.S. Cl. CPC G01S 15/588; G01S 15/025; G01S 13/58

(57) ABSTRACT

The present invention relates to an object trajectory estimation technology. A system for three-dimensional (3D) object trajectory estimation according to an exemplary embodiment of the present invention includes: an infrared sensor frame installed in a target space area; an acoustic sensor module installed in the target space area; and a processing unit configured to estimate a trajectory of an object within the target space area on the basis of pieces of data generated from the infrared sensor frame and pieces of data generated from the acoustic sensor module.

### CROSS-REFERENCE TO RELATED APPLICATION

This application claims priority to and the benefit of Korean Patent Application No. 10-2018-0072016, filed on Jun. 22, 2018, the disclosure of which is incorporated herein by reference in its entirety.

### BACKGROUND

### 1. Field of the Invention

The present invention relates to an object trajectory estimation technology, and more specifically, to a system and method for estimating a trajectory of an object in three-dimensional (3D) space.

### 2. Discussion of Related Art

In recent years, the market for virtual sports simulators for ball games has rapidly been growing, and research on ball speed estimation, launch angle estimation, and spin estimation, which are key technologies for inventing such simulators, is actively being conducted.

The types of virtual sports have been diversified starting from screen-golf to screen-baseball, tennis, soccer, and the like. Most of the virtual sports simulators use a computer vision technology to recognize a ball and analyze a motion of the ball, such as a velocity and trajectory of the ball.

However, due to the nature of the computer vision technology, not only are two or more super-speed cameras required for precise analysis but also the range of area to be analyzed is significantly limited since the cameras are fixed.

Therefore, with the exception of golf in which a ball is always swung from a constant position, it is difficult to utilize the computer vision technology in sports simulation for ball games, such as baseball, tennis, and soccer, in which characteristically a hitting point of a ball changes.

### SUMMARY OF THE INVENTION

The present invention aims to solve the above-described problems and provide a system and method for estimating a trajectory of a moving object in 3 dimensions using an infrared scanning scheme and acoustic sensors.

In one general aspect, there is provided a system for three-dimensional (3D) object trajectory estimation, including: an infrared sensor frame installed in a target space area; an acoustic sensor module installed in the target space area; and a processing unit configured to estimate a trajectory of an object within the target space area on the basis of pieces of data generated from the infrared sensor frame and pieces of data generated from the acoustic sensor module.

The infrared sensor frame may include a plurality of infrared sensors installed in the frame, and the plurality of infrared sensors output sensing data to the processing unit when the object passing through the frame is detected.

The acoustic sensor module may include a plurality of acoustic sensors which are each configured to obtain sound within the target space area and output a sound signal corresponding to the obtained sound to the processing unit.

The processing unit may include: an infrared sensor processing module configured to determine a position of the object on the frame on the basis of the pieces of data generated from the infrared sensor frame and output object position data and object detection time data; an acoustic sensor processing module configured to determine an impact position by analyzing the pieces of data generated from the acoustic sensor module and output impact position data and impact occurrence time data; and an object trajectory estimation module configured to estimate the trajectory of the object on the basis of the object position data, the object detection time data, the impact position data, and the impact occurrence time data.

The acoustic sensor processing module may determine an impact sound signal by analyzing the pieces of data generated from the acoustic sensor module and determine the impact position by analyzing the determined impact sound signal.

The object trajectory estimation module may store position values of the plurality of infrared sensors of the infrared sensor frame in a world coordinate system and position values of the plurality of acoustic sensors of the acoustic sensor module in the world coordinate system.

The object trajectory estimation module may convert the object position data and the impact position data into position values in the world coordinate system and then estimate the trajectory of the object.

The object trajectory estimation module may calculate a launch angle of the object according to Equation 6 below:

$$\{ \begin{matrix}{θ}_{el} = {tan}^{- 1} ( \frac{{P}_{sz} - {P}_{lz}}{{P}_{sy} - {P}_{ly}} ) \\ {θ}_{az} = {tan}^{- 1} ( \frac{{P}_{sx} - {P}_{lx}}{{P}_{sy} - {P}_{ly}} )\end{matrix} ,$$

wherein Pₛ(x, y, z) is object position data, P₁(x, y, z) is impact position data generated from the acoustic sensor processing module, θₑₗ is an angle between a direction of movement of the object and the ground, and θ_{az} is a horizontal angle of the direction of movement with respect to an impact center of the object.

The object trajectory estimation module may calculate a moving velocity of the object according to Equation 8 below:

v=\sqrt{vₓ²+v_{y}²+v_{z}²},

wherein vₓ denotes a moving velocity of the object with respect to an X-axis and is defined as

$${v}_{x} = \frac{{P}_{sx} - {P}_{lx}}{{t}_{s} - {t}_{l}} ,$$

v_{y} denotes a moving velocity of the object with respect to a Y-axis and is defined as

$${v}_{y} = \frac{{P}_{sy} - {P}_{ly}}{{t}_{s} - {t}_{l}} ,$$

v_{z} denotes a moving velocity of the object with respect to a Z-axis and is defined as

$${v}_{z} = \frac{{P}_{sz} - {P}_{lz}}{{t}_{s} - {t}_{l}} ,$$

Pₛ(x, y, z) is object position data generated from the infrared sensor processing module, P₁(x, y, z) is impact position data generated from the acoustic sensor processing module, tₛ denotes object detection time data, and t₁ denotes impact occurrence time data.

In another general aspect, there is provided a method for three-dimensional (3D) object trajectory estimation, including: detecting, by infrared sensors installed in a target space area, an object passing through a frame and outputting sensing data; outputting, by each acoustic sensor installed in the target space area, a sound signal corresponding to obtained sound; determining a position of the object on the frame on the basis of the sensing data and outputting object position data and object detecting time data; determining an impact position for th object on the basis of the sound signals and outputting impact position data and impact occurrence time data; and estimating a trajectory of the object on the basis of the object position data, the object detection time data, the impact position data, and the impact occurrence data.

The determining of the impact position may include determining an impact sound signal by analyzing the sound signal and determining the impact position by analyzing the determined impact sound signal.

The estimating of the trajectory of the object may include converting the object position data and the impact position data into position values in a world coordinate system.

The estimating of the trajectory of the object may include calculating a launch angle of the object according to Equation 6 below:

$$\{ \begin{matrix}{θ}_{el} = {tan}^{- 1} ( \frac{{P}_{sz} - {P}_{lz}}{{P}_{sy} - {P}_{ly}} ) \\ {θ}_{az} = {tan}^{- 1} ( \frac{{P}_{sx} - {P}_{lx}}{{P}_{sy} - {P}_{ly}} )\end{matrix} ,$$

wherein Pₛ(x, y, z) is object position data, P₁(x, y, z) is impact position data generated from an acoustic sensor processing module, θₑₗ is an angle between a direction of movement of the object and the ground, and θ_{az} is a horizontal angle of the direction of movement with respect to an impact center of the object.

The estimating of the trajectory of the object may include calculating a moving velocity of the object according to Equation 8 below:

v=\sqrt{vₓ²+v_{y}²+v_{z}²},

wherein vₓ denotes a moving velocity of the object with respect to an X-axis and is defined as

$${v}_{x} = \frac{{P}_{sx} - {P}_{lx}}{{t}_{s} - {t}_{l}} ,$$

v_{y} denotes a moving velocity of the object with respect to a Y-axis and is defined as

$${v}_{y} = \frac{{P}_{sy} - {P}_{ly}}{{t}_{s} - {t}_{l}} ,$$

v_{z} denotes a moving velocity of the object with respect to a Z-axis and is defined as

$${v}_{z} = \frac{{P}_{sz} - {P}_{lz}}{{t}_{s} - {t}_{l}} ,$$

Pₛ(x, y, z) is object position data generated from an infrared sensor processing module, P₁(x, y, z) is impact position data generated from an acoustic sensor processing module, tₛ denotes object detection time data, and t₁ denotes impact occurrence time data.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating an example in which a system for three-dimensional (3D) object trajectory estimation in accordance with one exemplary embodiment of the present invention is applied;

FIG. 2 is a diagram illustrating an example of a processing unit of the system for 3D object trajectory estimation according to the exemplary embodiment of the present invention;

FIG. 3 is a functional block diagram illustrating in detail a processor of the processing unit of the system for 3D object trajectory estimation according to the exemplary embodiment of the present invention;

FIG. 4 is a block diagram illustrating main components of the system for 3D object trajectory estimation according to the exemplary embodiment of the present invention; and

FIG. 5 is a diagram for describing operations of the system for 3D object trajectory estimation according to the exemplary embodiment of the present invention.

### DETAILED DESCRIPTION OF PREFERRED EMBODIMENTS

Detailed example embodiments of the present invention are disclosed herein. However, specific structural and functional details disclosed herein are merely representative for purposes of describing the example embodiments of the present invention. The example embodiments of the present invention may, however, be embodied in many alternate forms and should not be construed as limited to only the embodiments set forth herein.

Accordingly, while the example embodiments of the present invention are capable of various modifications and alternative forms, the embodiments thereof are shown by way of example in the drawings and will herein be described in detail. It should be understood, however, that there is no intent to limit the example embodiments of the present invention to the particular forms disclosed, but to the contrary, the example embodiments of the present invention are to cover all modifications, equivalents, and alternatives falling within the scope of the example embodiments of the present invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments of the present invention.

It will be understood that when an element is referred to as being “connected” or “coupled” to another element, it may be directly connected or coupled to another element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the example embodiments of the present invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Hereinafter, a system and method for three-dimensional (3D) object trajectory estimation according to the present invention will be described in detail with reference to the accompanying drawings.

The 3D object trajectory estimation technology according to the present invention may be used in various fields, such as ball trajectory estimation of a virtual sports simulator for sports requiring balls.

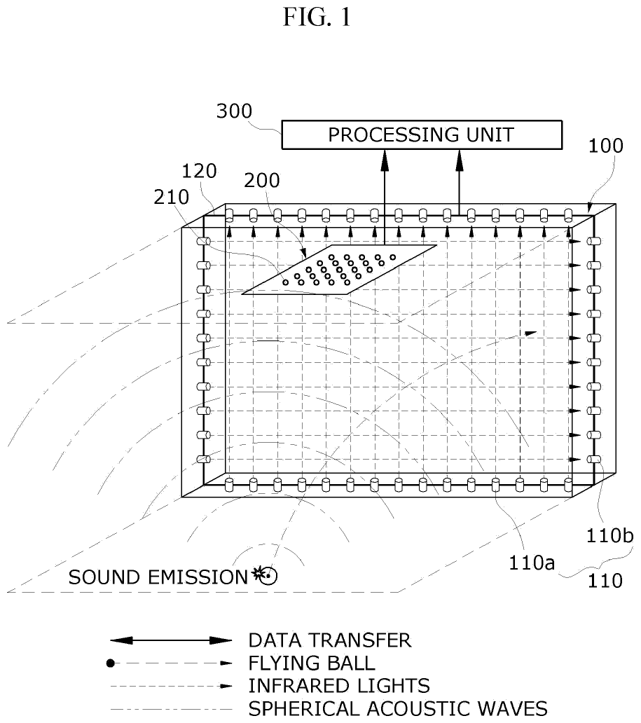

FIG. 1 is a diagram illustrating an example in which a system for 3D object trajectory estimation in accordance with one exemplary embodiment of the present invention is applied.

Referring to FIG. 1, the system for 3D ball trajectory tracking (hereinafter referred to as a “system”) in accordance with one exemplary embodiment of the present invention is implemented to track the trajectory of an object in 3D space on the basis of the time and position at which the object (e.g., ball or the like) passes through an infrared sensor frame and the time and position at which the object is hit, both of which are analyzed based on sound obtained by an acoustic sensor.

To this end, the system 1 may include an infrared sensor frame 100 which is installed in a target space area and is provided in advance for tracking a target object, an acoustic sensor module 200 installed in the target space area, and a processing unit 300 which tracks the trajectory of the object in 3D space on the basis of information from the infrared sensor frame 100 and information from the acoustic sensor module 200.

The infrared sensor frame 100 includes a plurality of infrared sensors 110 arranged to detect an object (e.g., a ball or the like) that passes through the 3D target space area previously provided.

For example, as in the embodiment of the present invention, the plurality of infrared sensors 110 are installed in a frame 120 disposed in the target space area and detect an object passing through the frame 120.

The plurality of infrared sensors 110 are composed of light-emitting sensors 110a configured to output infrared rays and light-receiving sensors 110b configured to receive infrared rays.

When the object passes through the frame 120, some of the infrared rays emitted from the light-emitting sensors 110a are blocked by the object and cannot be received by the light-receiving sensors 110b.

Accordingly, the light-receiving sensors 110b that did not receive the infrared rays output electrical signals different from those output when the infrared rays are received. In this specification, such electrical signals are referred to as “sensing data.”

In this case, the plurality of infrared sensors 110 are appropriately installed in the frame 120 so as not to fail in detecting an object passing through the frame 120.

Therefore, the number, installation spacing, and installation positions of the plurality of infrared sensors 110 installed in the frame may be selected variously.

In addition, the sensing data output from the light-receiving sensors 110b are transmitted to the processing unit 300 and used to estimate the trajectory of the object.

The acoustic sensor module 200 is composed of a plurality of acoustic sensors 210 configured to output electrical signals (e.g., voltages and the like) that correspond to obtained external sound.

For example, a micro-electro-mechanical system (MEMS) microphone may be used as the acoustic sensor, but the type of acoustic sensor is not limited thereto.

In the embodiment of the present invention, the plurality of acoustic sensors 210 obtain sound within the target space area and output electrical signals corresponding to the obtained sound. In this specification, such electrical signals are referred to as “sound signals.”

In particular, the plurality of acoustic sensors 210 output sound signals that correspond to sound (impact sound) generated when the object in the target space area is hit, and such sound signals are referred to as “impact sound signals” in this specification.

That is, in this specification, the sound signal includes an impact sound signal.

The sound signals output by the plurality of acoustic sensors 210 are transmitted to the processing unit 300 and used by the processor 400 to estimate the trajectory of the object.

The acoustic sensor module 200 may be preferably installed at a position at which the impact sound within the target space area can be accurately obtained.

Since the acoustic sensor module 200 is composed of a plurality of acoustic sensors 210 and each acoustic sensor 210 transmits a sound signal corresponding to obtained sound to the processing unit 300, the processing unit 300 may obtain sound signals through a plurality of channels.

The more acoustic sensors 210 that constitute the acoustic sensor module 200, the more accurate the object trajectory estimation is. However, when the acoustic sensor module 200 is constructed using too many acoustic sensors 210, prices may become expensive and thus an appropriate number of acoustic sensors 210 is required.

In addition, even when the acoustic sensors are identical, the plurality of acoustic sensors may output different electrical signals for the same sound pressure.

An operation of appropriately calibrating voltage values for the sound pressure may be performed on the plurality of acoustic sensors 210 included in the acoustic sensor module 200.

For example, “Free-field calibration of MEMS microphone array used for acoustic holography” introduced by International Congress on Sound and Vibration (ICSV) 21 may be used in pre-calibration of sound pressure of the acoustic sensors, but the embodiment is not limited thereto.

The processing unit 300 is implemented to estimate the trajectory of an object in 3D space on the basis of the sensing data generated from the plurality of infrared sensors 110 of the infrared sensor frame 100 and the sound signals from the plurality of acoustic sensors 210 of the acoustic sensor module 200.

Meanwhile, since the trajectory of the object is estimated based on the sensing data obtained by the plurality of infrared sensors 110 and the sound signals obtained by the plurality of acoustic sensors 210, relative position values of the plurality of infrared sensors 110 and the plurality of acoustic sensors 210 should be expressed in the same world coordinate system.

Thus, the processing unit 300 stores the position values of the plurality of infrared sensors 110 with respect to the world coordinate system and the position values of the plurality of acoustic sensors 210 with respect to the world coordinate system.

The configuration and functions of the processing unit 300 will be described below with reference to the accompanying drawings.

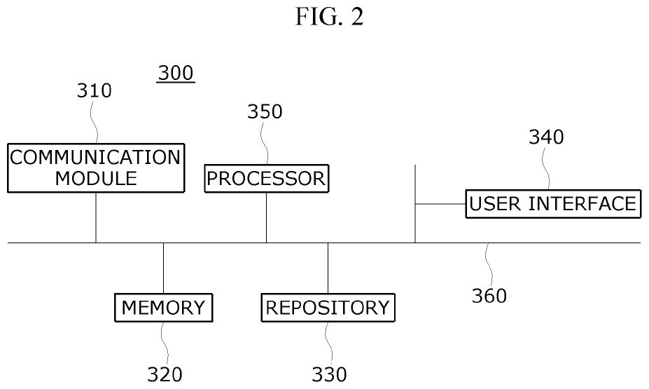

FIG. 2 is a diagram illustrating an example of the processing unit of the system for 3D object trajectory estimation according to the exemplary embodiment of the present invention.

As shown in FIG. 2, the processing unit 300 may include at least one communication module 310 for transmitting and receiving a signal (or data) to and from an external device, at least one memory 320 for storing an algorithm (or program) necessary for performing a function, storing a result of performing an operation, and the like, at least one repository 330, a user interface 340 for interfacing with a user, at least one processor 350 for performing functions, and the like.

The above-described components 310 to 350 may be implemented to transmit and receive signals (or data) using a communication bus 360 within the processing unit 300.

For example, various devices, such as personal computers (PCs), notebook computers, and the like, each including hardware, such as a memory, a hard disk, a processor, a display module, a keyboard, a communication module, an internal bus, and the like, may be used as the processing unit 300.

The communication module 310, which is configured to transmit and receive a signal (or data) to and from an external device, receives the sensing data generated from the plurality of infrared sensors 110 of the infrared sensor frame 100 and the sound signals from the plurality of acoustic sensors 210 of the acoustic sensor module 200 and provides the sensing data and the sound signals to the processor 350.

In the present embodiment, one communication module 310 may be implemented to receive both the sensing data and the sound signal or two communication modules may be implemented to each receive one of the sensing data and the sound signal.

An algorithm (or program) necessary for performing functions of the processor 350 may be stored in the memory 320 and the repository 330 may be used to store the result of performing an operation of the processor 350.

The memory 320 and the repository 330 may include volatile or non-volatile storage media in various forms.

The memory 320 may include read-only memory (ROM) and random access memory (RAM), and the repository 330 may include a NAND flash memory such as a compact flash (CF) card, a secure digital (SD) card, a memory stick, a solid-state drive (SSD), and a micro SD card, a magnetic computer memory device such as a hard disk drive (HDD), and an optical disc drive such as a compact disc read-only memory (CD-ROM), a digital versatile disc (DVD)-ROM, etc.

The user interface 340 is a configured to interface with a user and may include an input device and an output device.

The processor 350 is implemented to estimate the trajectory of an object in 3D space on the basis of the sensing data generated from the plurality of infrared sensors 110 and the sound signals from the plurality of acoustic sensors 210.

The function of the processor 350 may be performed using the algorithm (or program) necessary for performing the function, which is loaded from the external memory 320.

Optionally, the processor 350 may include an internal memory in which an algorithm (or program) necessary for performing the function thereof is stored, and perform the function using the algorithm (or program) that is stored in and loaded from the internal memory.

Specific functions and operations of the processor 350 will be described below with reference to the accompanying drawings.

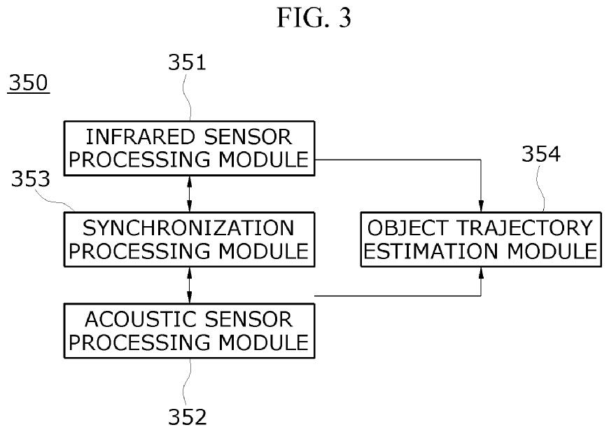

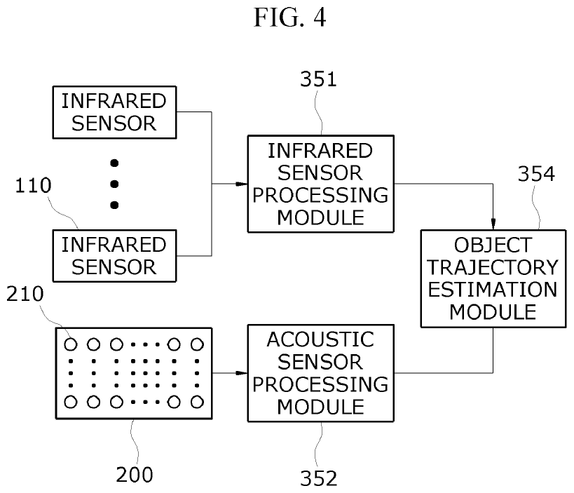

FIG. 3 is a functional block diagram illustrating in detail the processor of the processing unit of a system for 3D object trajectory estimation according to the exemplary embodiment of the present invention, and FIG. 4 is a block diagram illustrating main components of the system for 3D object trajectory estimation according to the exemplary embodiment of the present invention.

Referring to FIGS. 3 and 4, the processor 350 of the processing unit 300 of the system for 3D object trajectory estimation in accordance with the exemplary embodiment of the present invention may include an infrared sensor processing module 351, an acoustic sensor processing module 352, a synchronization processing module 353, and an object trajectory estimation module 354.

Although the infrared sensor processing module 351, the acoustic sensor processing module 352, the synchronization processing module 353, and the object trajectory estimation module 354 are implemented by one processor 350 in the present embodiment, they may be implemented by multiple processors.

The infrared sensor processing module 351 receives sensing data generated from the plurality of infrared sensors 110, determines a position of an object on the frame 120, and outputs data (object position data) related to the position of the object on the frame 120 to the object trajectory estimation module 354, according to preset program.

The infrared sensor processing module 351 may determine the position of the object and output the position of the object to the object trajectory estimation module 354 by converting the object position data into a position value in the world coordinate system.

Alternatively, when the object trajectory estimation module 354 is implemented to convert the object position data generated from the infrared sensor processing module 351 into a position value in the world coordinate system, the infrared sensor processing module 351 may output the object position data to the object trajectory estimation module 354 without converting the object position data to into the position value in the world coordinate system.

Since the plurality of infrared sensors 110 installed in the frame 120 have a positional relationship with each other, the infrared sensor processing module 351 may determine the position of the object on the frame 120 by checking from which infrared sensors 120 pieces of sensing data are received.

That is, since pieces of sensing data received by the infrared sensor processing module 351 are output from the infrared sensors 110 that have detected the object passing through the frame, it is possible to determine the position of the object by analyzing the pieces of sensing data.

In addition, since the infrared sensor processing module 351 receives the sensing data generated from the infrared sensors 110 when the object passes through the infrared sensor frame 100, the infrared sensor processing module 351 records the time at which the sensing data is received.

In the specification, data related to the time recorded by the infrared sensor processing module 351 at the moment of receiving the sensing data is referred to as “object detection time data.”

The infrared sensor processing module 351 outputs the object position data and the object detection time data to the object trajectory estimation module 354.

The acoustic sensor processing module 352 determines a position (impact position) at which the impact sound occurs on the basis of the sound signals from the plurality of acoustic sensors 210 and outputs data (impact position data) related to the impact position to the object trajectory estimation module 354.

After determining the impact position, the acoustic sensor processing module 352 may convert the impact position data into a position value in the world coordinate system and output the converted position value to the object trajectory estimation module 354.

Alternatively, when the object trajectory estimation module 354 is implemented to convert the impact position data generated from the acoustic sensor processing module 352 into a position value in the world coordinate system, the acoustic sensor processing module 352 may output the impact position data to the object trajectory estimation module 354 without converting the impact position data into a position value in the world coordinate system.

Additionally, the acoustic sensor processing module 352 outputs the time data (impact occurrence time data) at which the impact sound is received, along with the impact position data, to the object trajectory estimation module 454.

That is, the acoustic sensor processing module 352 outputs the impact position data and the impact occurrence time data to the object trajectory estimation module 354.

The acoustic sensor processing module 352 may obtain the sound signals at a preset sampling rate (e.g., 192 kHz).

However, the higher the sampling rate is, the more accurate the object trajectory estimation is, but the higher the performance of the acoustic sensor processing module 352 which is required. Therefore, an appropriate sampling rate should be chosen.

In addition, the sound signals input to the acoustic sensor processing module 352 are in an analog form, and thus the acoustic sensor processing module 352 converts the sound signals in an analog form into sound signals in a digital form.

Meanwhile, the acoustic sensor module 200 may obtain other sound (hereinafter referred to as “noise”) in addition to the impact sound.

Accordingly, the acoustic sensor processing module 352 may receive sound signals from the plurality of acoustic sensors 210 and then analyze the sound signals to determine an impact position on the basis of a sound signal (impact sound signal) determined as an impact sound.

That is, the acoustic sensor processing module 352 may determine the impact sound signal among the sound signals from the plurality of acoustic sensors 210 and determine an impact position on the basis of the determined impact sound signal.

Various methods of determining an impact sound signal among sound signals may be used. For example, the acoustic sensor processing module 352 may use the Mel-frequency cepstral coefficient-feed forward neural network (MFCC-FFNN) scheme to determine an impact sound signal among sound signals.

A method in which the acoustic sensor processing module 352 analyzes sound signals to determine an impact sound signal and determines an image position on the basis of the determined impact sound signal will be described below.

The synchronization processing module 353 is configured to synchronize times of the infrared sensor processing module 351 and the acoustic sensor processing module 352.

The synchronization processing module 353 may synchronize times of the infrared sensor processing module 351 and the acoustic sensor processing module 352 using one method selected from various known method for synchronizing time between two devices.

The object trajectory estimation module 354 estimates the trajectory of the object on the basis of the object position data and object detection time from the infrared sensor processing module 351 and the impact position data and impact occurrence time data generated from the acoustic sensor processing module 352.

In this case, the object trajectory estimation module may estimate information about at least one of a launch angle and velocity of the object.

In addition, the object trajectory estimation module 354 stores position values of the plurality of infrared sensors 110 in the world coordinate system and position values of the plurality of acoustic sensors 210 in the world coordinate system.

Accordingly, the position of the object on the frame 120 and the impact position can be expressed in one world coordinate system, which allows the object trajectory estimation module 354 to estimate the trajectory of the object.

That is, the object trajectory estimation module 354 may convert the object position data into a position value in the world coordinate system, convert the impact position data into a position value in the world coordinate system, and then estimate the trajectory of the object on the basis of the converted values.

A method in which the object trajectory estimation module 354 estimates the trajectory of the object will be described below.

Hereinafter, a process in which the acoustic sensor processing module 352 determines the impact position on the basis of sound signals from the plurality of acoustic sensors 210 will be described.

The acoustic sensor processing module 352 receives sound signals from the acoustic sensor module 200, then determines an impact sound signal by analyzing the received sound signals, and determines an impact position on the basis of the determined impact sound signal.

For example, the acoustic sensor processing module 352 may use a delay-and-sum beamforming (DSBF) scheme in determining the impact position.

A sound signal (or sound pressure) output from an arbitrary acoustic sensor j will be defined with reference to time, as shown in Equation 1 below.

$${p}_{j} ( t ) = \frac{1}{\vert {r}_{s} \vert} s ( t - \frac{\vert {r}_{s} \vert}{c} ) \qquad [ Equation 1 ]$$

Here, pⱼ(t) denotes a sound signal (sound pressure) output from the arbitrary acoustic sensor j at time t, s(t) denotes a position of an actual sound source occurred at time t, which is defined as coordinates (xₛ,yₛ,zₛ), c denotes a velocity of acoustic waves, and rₛ denotes a distance vector between the acoustic sensor j and the sound source s(t).

In addition, a DSBF output value for a candidate position of an arbitrary value sampled from a digital value for the sound signal output from the arbitrary acoustic sensor j may be calculated by Equation 2 below.

$$bf ( {P}_{s} , i ) = \frac{1}{M} {\sum }_{j = 1}^{M} {p}_{j} [ i - {δ}_{j} ( {P}_{s} ) ] \qquad [ Equation 2 ]$$

Here, bf(Pₛ, i) denotes a DSBF output value for a candidate position (candidate sound source position Ps) for an index i of an arbitrary value sampled from a digital value for the sound signal output from the arbitrary acoustic sensor j, M denotes the total number of acoustic sensors, and pⱼ[i] denotes a sound signal data stream output from the arbitrary acoustic sensor j.

In addition, δⱼ(Pₛ) denotes a delay distance for acoustic wave propagation between the candidate sound source position Pₛ and a position Pₘⱼ of the arbitrary acoustic sensor j at time t, and may be defined as Equation 3 below.

$${δ}_{j} ( {P}_{s} ) = \frac{{f}_{s}}{c} \vert {P}_{s} - {P}_{mj} \vert \qquad [ Equation 3 ]$$

Meanwhile, a magnitude of the DSBF output value for the candidate sound source portion may be obtained as an average of L samples.

Here, L indicates the number of valid samples for the sound signal recognized as a source of impact sound, and a method of detecting a source of valid impact sound using the MFCC-FFNN scheme may be used to obtain L, or a method of identifying a source of valid impact sound using a threshold value of a background sound source as shown in Equation 4 may be used.

$$L = {i}_{e} - {i}_{s} , \{ \begin{matrix}{i}_{s} \text{:=} i - S , \sqrt{{\sum }_{i = 1}^{S} {P ( i )}^{2}} > K \times {B}_{RMS} \\ {i}_{e} \text{:=} i + S , \sqrt{{\sum }_{i = 1}^{S} {P ( i )}^{2}} < K \times {B}_{RMS}\end{matrix} \qquad [ Equation 4 ]$$

Here, L denotes the number of valid samples for a sound signal recognized as a source of impact sound, iₛ denotes an index of a start sample, iₑ denotes an index of the last sample, S is a length of a sample to be measured, P(i) denotes the sum of sound signals from all acoustic sensors in sample i, K denotes a threshold value arbitrarily defined by a user, and B_{RMS} denotes a square root of a background sound source.

Finally, the acoustic sensor processing module 352 determines an impact position P_{bf} according to Equation 5 below.

$${P}_{bf} = \begin{matrix}max \\ {P}_{s}\end{matrix} [ bf ( {P}_{s} , i ) ] \qquad [ Equation 5 ]$$

Hereinafter, a process in which the object trajectory estimation module 354 estimates the trajectory of an object will be described.

The object trajectory estimation module 354 estimates the trajectory of the object on the basis of the object position data and sensing data reception time information from the infrared sensor processing module 351 and the impact position data and impact occurrence time data generated from the acoustic sensor processing module 352.

In this case, the object trajectory estimation module 354 may estimate information about at least one of a launch angle and velocity of the object.

The object trajectory estimation module 354 may calculate an angle (launch angle) of the object with respect to the ground when the object moves as the object is hit, according to Equation 6 below.

$$\{ \begin{matrix}{θ}_{el} = {tan}^{- 1} ( \frac{{P}_{sz} - {P}_{lz}}{{P}_{sy} - {P}_{ly}} ) \\ {θ}_{az} = {tan}^{- 1} ( \frac{{P}_{sx} - {P}_{lx}}{{P}_{sy} - {P}_{ly}} )\end{matrix} \qquad [ Equation 6 ]$$

Here, Pₛ(x, y, z) is object position data generated from the infrared sensor processing module 351, P₁(x, y, z) is impact position data generated from the acoustic sensor processing module 352, θₑₗ is an angle between a direction of movement of the object and the ground, and θ_{az} is a horizontal angle of the direction of movement with respect to an impact center of the object.

All of the infrared sensors 110, the acoustic sensor module 200, and the infrared sensor processing module 351, acoustic sensor processing module 352, and object trajectory estimation module 354 constituting the processing unit 300 are of fixed type, and thus P_{sy} and P_{1z} are all constants.

In addition, the object trajectory estimation module 354 may calculate moving velocities of the object with respect to X-, Y-, and Z-axes according to Equation 7 below.

$$\{ \begin{matrix}{v}_{x} = \frac{{P}_{sx} - {P}_{lx}}{{t}_{s} - {t}_{l}} \\ {v}_{y} = \frac{{P}_{sy} - {P}_{ly}}{{t}_{s} - {t}_{l}} \\ {v}_{z} = \frac{{P}_{sz} - {P}_{lz}}{{t}_{s} - {t}_{l}}\end{matrix} \qquad [ Equation 7 ]$$

Here, tₛ denotes object detection time data generated from the infrared sensor processing module 351 and t₁ denotes impact occurrence time data generated from the acoustic sensor processing module 352.

In addition, the object trajectory estimation module 354 ultimately calculates the moving velocity of the object by applying the moving velocities calculated with reference to the respective axes according to Equation 7 to Equation 8 below.

v=\sqrt{vₓ²+v_{y}²+v_{z}²} [Equation 8]

The components and functions of the respective components of the system for 3D object trajectory estimation according to the exemplary embodiment of the present invention have been described above. The operations of the system for 3D object trajectory estimation according to the exemplary embodiment will be described hereinafter.

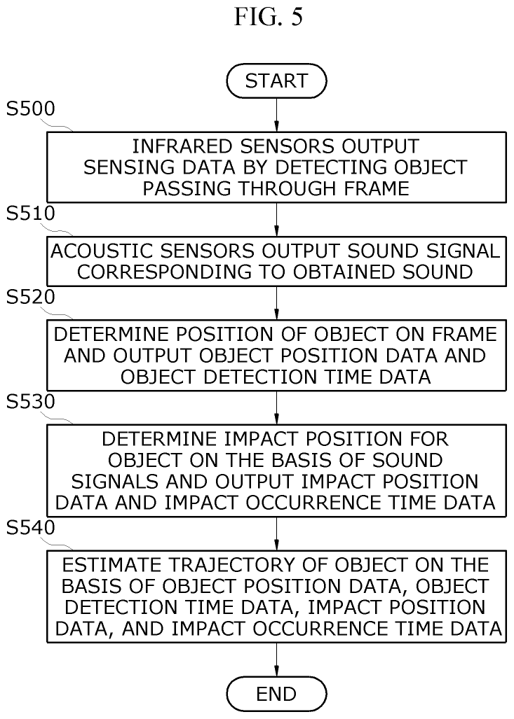

FIG. 5 is a diagram for describing operations of the system for 3D object trajectory estimation according to the exemplary embodiment of the present invention.

The stepwise operations shown in FIG. 5 may be performed by the system for 3D object trajectory estimation described with reference to FIGS. 1 to 4. The infrared sensors 110 of the infrared sensor frame 100 output sensing data by detecting an object passing through the frame 120 (S500), and the acoustic sensors 210 of the acoustic sensor module 200 outputs sound signals corresponding to obtained sound (S510).

Then, the infrared sensor processing module 351 of the processing unit 300 determines a position of the object on the frame 120 on the basis of the sensing data obtained in operation S500 and outputs object position data and object detection time data (S520).

In addition, the acoustic sensor processing module 352 of the processing unit 300 determines a position at which the object is hit on the basis of the sound signal obtained in operation S510 and outputs impact position data and impact occurrence time data (S530).

Then, the object trajectory estimation module 354 of the processing unit 300 estimates the trajectory of the object on the basis of the object position data and object detection time data obtained in operation S520 and the impact position data and impact occurrence time data obtained in operation S530 (S540).

As described above, according to the technology for 3D ball trajectory estimation according to the present invention, a system and method for estimating a trajectory of an object moving in 3D space by using an infrared scanning scheme and acoustic sensors are provided.

According to the present invention, since coordinates, velocity and direction of the object can be determined using inexpensive acoustic sensors, an infrared light-emitting diode (LED) (light emission), and a phototransistor (light reception), it is possible to construct the system at a lower cost as compared to a virtual sports simulator that requires costly high-speed stereo cameras.

In addition, since a hitting position is estimated using sound information, a range of recognition is wider than a conventional camera-based scheme.

In the description above, although all of the components of the embodiments of the present invention may have been explained as assembled or operatively connected as a unit, the present invention is not intended to be limited to such embodiments. Rather, within the objective scope of the present invention, the respective components may be selectively and operatively combined in any numbers. Each of the components may be also implemented as hardware while the respective ones may be selectively combined in part or as a whole and implemented in a computer program having program modules for executing functions of the hardware equivalents. The computer program may be stored in computer readable media, such as a Universal Serial Bus (USB) memory, a CD disk, flash memory, and the like, which can realize the embodiments of the present invention. Examples of the computer readable media may include magnetic recording media, optical recording media, and carrier wave media.

While the system and method for 3D object trajectory estimation according to the present invention have been particularly shown and described with reference to the exemplary embodiments, it will be understood by those of ordinary skill in the art that various changes in form and details may be made therein without departing from the spirit and scope of the present invention as defined by the following claims.

What is claimed is:

1. A system for three-dimensional (3D) object trajectory estimation, comprising:
an infrared sensor frame installed in a target space area;
an acoustic sensor module installed in the target space area; and
a processing unit configured to estimate a trajectory of an object within the target space area on the basis of pieces of data generated from the infrared sensor frame and pieces of data generated from the acoustic sensor module.

2. The system of claim 1, wherein the infrared sensor frame includes a plurality of infrared sensors installed in the frame, and the plurality of infrared sensors output sensing data to the processing unit when the object passing through the frame is detected.

3. The system of claim 1, wherein the acoustic sensor module includes a plurality of acoustic sensors which are each configured to obtain sound within the target space area and output a sound signal corresponding to the obtained sound to the processing unit.

4. The system of claim 1, wherein the processing unit includes:
an infrared sensor processing module configured to determine a position of the object on the frame on the basis of the pieces of data generated from the infrared sensor frame and output object position data and object detection time data;
an acoustic sensor processing module configured to determine an impact position by analyzing the pieces of data generated from the acoustic sensor module and output impact position data and impact occurrence time data; and
an object trajectory estimation module configured to estimate the trajectory of the object on the basis of the object position data, the object detection time data, the impact position data, and the impact occurrence time data.

5. The system of claim 4, wherein the acoustic sensor processing module determines an impact sound signal by analyzing the pieces of data generated from the acoustic sensor module and determines the impact position by analyzing the determined impact sound signal.

6. The system of claim 4, wherein the object trajectory estimation module stores position values of the plurality of infrared sensors of the infrared sensor frame in a world coordinate system and position values of the plurality of acoustic sensors of the acoustic sensor module in the world coordinate system.

7. The system of claim 6, wherein the object trajectory estimation module converts the object position data and the impact position data into position values in the world coordinate system and then estimates the trajectory of the object.

8. The system of claim 4, wherein the object trajectory estimation module calculates a launch angle of the object according to Equation 6 below:
$$\{ \begin{matrix}{θ}_{el} = {tan}^{- 1} ( \frac{{P}_{sz} - {P}_{lz}}{{P}_{sy} - {P}_{ly}} ) \\ {θ}_{az} = {tan}^{- 1} ( \frac{{P}_{sx} - {P}_{lx}}{{P}_{sy} - {P}_{ly}} )\end{matrix} ,$$
wherein Pₛ(x, y, z) is object position data, P₁(x, y, z) is impact position data generated from the acoustic sensor processing module, θₑₗ is an angle between a direction of movement of the object and the ground, and θ_{az} is a horizontal angle of the direction of movement with respect to an impact center of the object.

9. The system of claim 4, wherein the object trajectory estimation module calculates a moving velocity of the object according to Equation 8 below:
v=\sqrt{vₓ²+v_{y}²+v_{z}²},
wherein vₓ denotes a moving velocity of the object with respect to an X-axis and is defined as
$${v}_{x} = \frac{{P}_{sx} - {P}_{lx}}{{t}_{s} - {t}_{l}} ,$$
v_{y} denotes a moving velocity of the object with respect to a Y-axis and is defined as
$${v}_{y} = \frac{{P}_{sy} - {P}_{ly}}{{t}_{s} - {t}_{l}} ,$$
v_{z} denotes a moving velocity of the object with respect to a Z-axis and is defined as
$${v}_{z} = \frac{{P}_{sz} - {P}_{lz}}{{t}_{s} - {t}_{l}} ,$$
Pₛ(x, y, z) is object position data generated from the infrared sensor processing module, P₁(x, y, z) is impact position data generated from the acoustic sensor processing module, tₛ denotes object detection time data, and t₁ denotes impact occurrence time data.

10. A method for three-dimensional (3D) object trajectory estimation, comprising:
detecting, by infrared sensors installed in a target space area, an object passing through a frame and outputting sensing data;
outputting, by each acoustic sensor installed in the target space area, a sound signal corresponding to obtained sound;
determining a position of the object on the frame on the basis of the sensing data and outputting object position data and object detecting time data;
determining an impact position for th object on the basis of the sound signals and outputting impact position data and impact occurrence time data; and
estimating a trajectory of the object on the basis of the object position data, the object detection time data, the impact position data, and the impact occurrence data.

11. The method of claim 10, wherein the determining of the impact position includes determining an impact sound signal by analyzing the sound signal and determining the impact position by analyzing the determined impact sound signal.

12. The method of claim 10, wherein the estimating of the trajectory of the object includes converting the object position data and the impact position data into position values in a world coordinate system.

13. The method of claim 10, wherein the estimating of the trajectory of the object includes calculating a launch angle of the object according to Equation 6 below:
$$\{ \begin{matrix}{θ}_{el} = {tan}^{- 1} ( \frac{{P}_{sz} - {P}_{lz}}{{P}_{sy} - {P}_{ly}} ) \\ {θ}_{az} = {tan}^{- 1} ( \frac{{P}_{sx} - {P}_{lx}}{{P}_{sy} - {P}_{ly}} )\end{matrix} ,$$
wherein Pₛ(x, y, z) is object position data, P₁(x, y, z) is impact position data generated from an acoustic sensor processing module, θₑₗ is an angle between a direction of movement of the object and the ground, and θ_{az} is a horizontal angle of the direction of movement with respect to an impact center of the object.

14. The method of claim 10, wherein the estimating of the trajectory of the object includes calculating a moving velocity of the object according to Equation 8 below:
v=\sqrt{vₓ²+v_{y}²+v_{z}²},
wherein vₓ denotes a moving velocity of the object with respect to an X-axis and is defined as
$${v}_{x} = \frac{{P}_{sx} - {P}_{lx}}{{t}_{s} - {t}_{l}} ,$$
v_{y} denotes a moving velocity of the object with respect to a Y-axis and is defined as
$${v}_{y} = \frac{{P}_{sy} - {P}_{ly}}{{t}_{s} - {t}_{l}} ,$$
v_{z} denotes a moving velocity of the object with respect to a Z-axis and is defined as
$${v}_{z} = \frac{{P}_{sz} - {P}_{lz}}{{t}_{s} - {t}_{l}} ,$$
Pₛ(x, y, z) is object position data generated from an infrared sensor processing module, P₁(x, y, z) is impact position data generated from an acoustic sensor processing module, tₛ denotes object detection time data, and t₁ denotes impact occurrence time data.
